(19) United States
(12) Patent Application Publication
(10) Pub. No.: US 2011/0193800 A1
(43) Pub. Date: Aug. 11, 2011

(54) FLAT PANEL DISPLAY INTEGRATED WITH TOUCH SCREEN PANEL

(76) Inventors: Yang-Han Son, Yongin-city (KR); Chang-Sub Jung, Yongin-city (KR); Min-Seop Kim, Yongin-city (KR)

(21) Appl. No.: 12/949,760

(22) Filed: Nov. 18, 2010

(30) Foreign Application Priority Data
Feb. 10, 2010 (KR) 10-2010-0012399

(51) Int. Cl. G06F 3/041; G09G 3/36

(52) U.S. Cl. 345/173; 345/87

(57) ABSTRACT

A display apparatus includes a flat panel display (FPD), a touch screen panel provided on a front surface of the FPD, and a sealing material formed to surround external surfaces of the FPD and the touch screen panel.

### CROSS-REFERENCE TO RELATED APPLICATION

This application claims priority to and the benefit of Korean Patent Application No. 10-2010-0012399, filed on Feb. 10, 2010, in the Korean Intellectual Property Office, the entire content of which is incorporated herein by reference.

### BACKGROUND

1. Field

An aspect of an embodiment of the present invention relates to a flat panel display (FPD), and more particularly, to an FPD integrated with a touch screen panel.

2. Description of Related Art

A touch screen is an input device for selecting instruction contents displayed on the screen of a flat panel display (FPD) by a human hand or an object to input the command of a user.

Therefore, the touch screen panel is provided on the front face of the FPD to convert the contact position by the human hand or object into an electrical signal. Therefore, the instruction content selected in the contact position is received as an input signal.

Since the touch screen panel may replace an additional input device coupled to the image display device such as a keyboard or a mouse, the application of the touch screen panel is increasing.

In the conventional art, in attaching the touch screen panel to the front surface of the FPD, a double-sided tape is used. In this case, a foreign substance or moisture may penetrate the space created by the double-sided tape so that the picture quality of the FPD deteriorates.

### SUMMARY

Embodiments of the present invention are directed toward a flat panel display (FPD) integrated with a touch screen panel in which a sealing material is formed in order to block a foreign substance or moisture that penetrates a space between the flat panel display (FPD) and the touch screen panel attached to the FPD.

According to an embodiment of the present invention, there is provided a display apparatus including a flat panel display (FPD), a touch screen panel on a front surface of the FPD, and a sealing material surrounding external surfaces of the FPD and the touch screen panel.

The FPD may include a backlight module for transmitting light generated by a light source, a liquid crystal display (LCD) panel for displaying an image with the light, a mold frame for fixing the backlight module and the LCD panel, and a top chassis and a bottom chassis coupled to each other from top to bottom to fix the backlight module, the LCD panel, and the mold frame therebetween.

The display apparatus may further include a double-sided tape for attaching the touch screen panel to a partial top surface of the top chassis. The sealing material may include a synthetic resin material. The sealing material may be formed by insert molding.

According to another embodiment of the present invention, there is provided a display apparatus including a flat panel display (FPD) including a display panel, a mold frame for fixing the display panel, and a top chassis and a bottom chassis coupled to each other from top to bottom to fix the display panel and the mold frame therebetween, a double-sided tape on a partial top surface of the top chassis, a touch screen panel attached on a front surface of the FPD by the double-sided tape, and a first sealing material being adapted to contact one surface of the double-sided tape formed on the top chassis and to wrap around an inside surface of the top chassis opposite to the partial top surface.

The display apparatus may further include a second sealing material positioned at a region between the bottom chassis and the mold frame. The first sealing material or the second sealing material may surround four surfaces of the FPD. The first sealing material or the second sealing material may include an elastic material.

According to another embodiment of the present invention, a display apparatus includes a flat panel display (FPD) having a front side, a touch screen panel on the front side of the FPD, and a sealing material surrounding external surfaces of the FPD and the touch screen panel for sealing a space therebetween.

The FPD may include a display panel for displaying an image, a top chassis and a bottom chassis coupled to each other with the display panel therebetween, and a double-sided tape for attaching the touch screen panel to a partial top surface of the top chassis, wherein the sealing material surrounds the double-sided tape.

According to the embodiments of the present invention, a foreign substance or moisture is prevented or hindered from penetrating a space between the FPD and the touch screen panel attached to the FPD so that the screen of the FPD is prevented from deteriorating and that reliability of the FPD is improved.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective view illustrating a flat panel display (FPD) integrated with a touch screen panel according to an embodiment of the present invention;

FIG. 2 is a sectional view illustrating a part of FIG. 1;

FIG. 3 is an exploded perspective view of an FPD integrated with a touch screen panel according to another embodiment of the present invention; and

FIG. 4 is a sectional view illustrating a part of FIG. 3.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on another element or be indirectly on another element with one or more intervening elements interposed therebetween. Also, when an element is referred to as being “connected to” or “coupled to” another element, it can be directly connected to another element or be indirectly connected to another element with one or more intervening elements interposed therebetween. Hereinafter, like reference numerals refer to like elements.

Hereinafter, exemplary embodiments of the present invention will be described in detail with reference to the accompanying drawings.

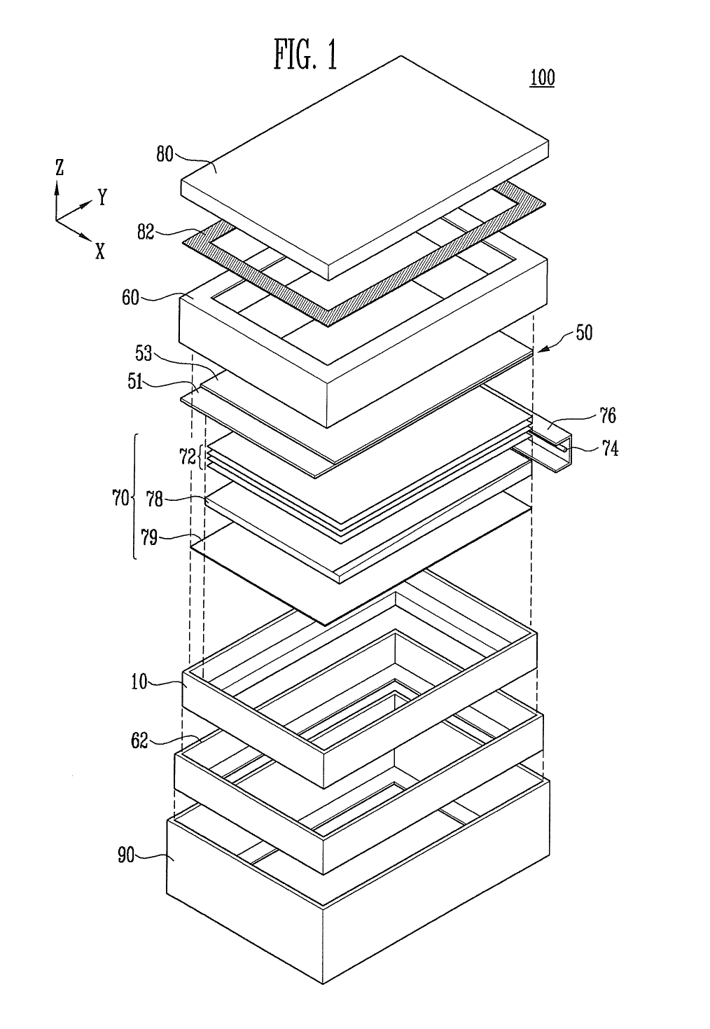

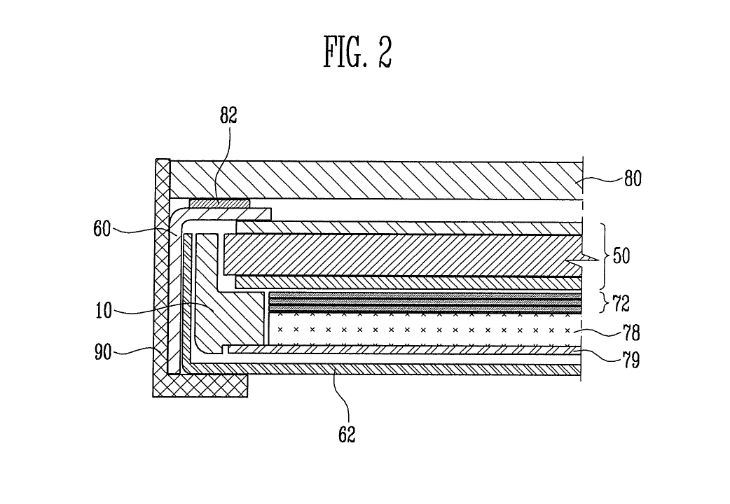

FIG. 1 is an exploded perspective view illustrating a flat panel display (FPD) integrated with a touch screen panel according to an embodiment of the present invention. FIG. 2 is a sectional view illustrating a specific part of FIG. 1.

In FIG. 1, the FPD is a liquid crystal display (LCD) according to an embodiment, but the present invention is not limited to the above. That is, the FPD may be realized as an organic light emitting display other than the LCD according to other embodiments.

Referring to FIG. 1, a touch screen panel 80 is attached by a double-sided tape 82 positioned on the front face frame of the FPD.

Here, the FPD is realized by the LCD and includes a backlight module 70 for transmitting light generated by a light source, an LCD panel 50 for displaying an image with the light, a top chassis 60 for fixing the backlight module 70 and the LCD panel 50, a bottom chassis 62, and a mold frame 10.

The backlight module 70 is supported by the lower bottom chassis 62 and is accommodated in the mold frame 10 to be fixed therein. The backlight module 70 includes a lamp 74 for emitting light and being located in a lamp cover 76, a light guide plate 78 for guiding light emitted from the lamp 74 to supply the guided light, and a reflect sheet 79 positioned under the light guide plate 78 to reflect light. In addition, an optical sheet 72 is formed on the light guide plate 78. A light emitting diode (LED) may be used as the lamp 74, and other suitable surface or linear light sources may be used.

The mold frame 10 fixes or secures the backlight module 70 and the LCD 50. As illustrated in FIG. 1, the inside wall of the mold frame 10 may contact the backlight module and the LCD panel.

The LCD panel 50 includes a TFT substrate 51 in which a plurality of pixels including TFTs are formed, a color filter substrate 53 positioned on the top of the TFT substrate 51, and a liquid crystal injected between the substrates. Polarizing plates are attached to the top of the color filter substrate 53 and to the bottom of the TFT substrate 51 to control the polarization direction of the visible light emitted by the backlight module 70.

The plurality of pixels are formed in the regions where data lines and gate lines cross each other on the transparent TFT substrate 51, and the TFTs are provided in the respective pixels. Here, the source electrodes of the TFTs are coupled to the data lines, and the drain electrodes of the TFTs are coupled to the pixel electrodes formed in the pixels. In addition, the gate electrodes of the TFTs are coupled to the gate lines.

On and off of the TFTs are determined by gate signals transmitted to the gate lines, and the data signals corresponding to the pixels are applied to the pixel electrodes through the source/drain electrodes of the TFTs. That is, the alignment of liquid crystal modules changes in accordance with the data signals so that the degree of transmission of light is controlled.

On the color filter substrate 53, R, G, and B color filters are formed in the regions corresponding to the pixels, and a common electrode is formed on the front surface of the color filters. Therefore, the light that passes through the TFT substrate and liquid crystal represents a specific color (e.g., R, G, or B) through the color filters so that gray levels are expressed in accordance with the degree of transmission of light.

The liquid crystal display panel 50, the backlight module 70, and the mold frame 10 for fixing the liquid crystal display panel 50 and the backlight module 70 are coupled to each other by the top chassis 60 and the bottom chassis 62 to be fixed. Therefore, the LCD may be constituted in accordance with the above described embodiment.

In addition, according to an embodiment of the present invention, the double-sided tape 82 is formed on the partial top surface of the top chassis 60 in order to attach the touch screen panel 80 to the front surface of the LCD.

Here, the touch screen panel 80 may be realized by various methods such as an electrostatic capacitance method and a resistance layer method.

However, when the touch screen panel 80 and the LCD are attached together through the double-sided tape 82, a space is created by the thickness of the double-sided tape 82 so that moisture or a foreign substance may penetrate the space.

According to the embodiment of the present invention illustrated in FIGS. 1 and 2, in order to prevent the foreign substance from penetrating the space created by the double-sided tape 82, a sealing material 90 is formed to surround the external surfaces (i.e., the four external surfaces of the top chassis 60 and the touch screen panel 80).

Here, the sealing material 90 may be formed of synthetic resin in the form of surrounding the external surfaces of the top chassis 60 and the touch screen panel 80 through insert molding.

After inserting the LCD to which the touch screen panel 80 is attached into a mold for forming the sealing material 90, a sealing solution for realizing the sealing material 90 is injected into the mold to form the sealing material 90 that surrounds the external surfaces (i.e., the four external surfaces of the top chassis 60 and the touch screen panel 80).

The mold is additionally manufactured to form the sealing material 90 on the external surfaces of the top chassis 60 and the touch screen panel 80 of the LCD by the insert molding method.

The sealing solution may be obtained by melting the synthetic resin material used as the sealing material 90. When the sealing solution is injected into the mold and is hardened, the sealing material 90 is realized.

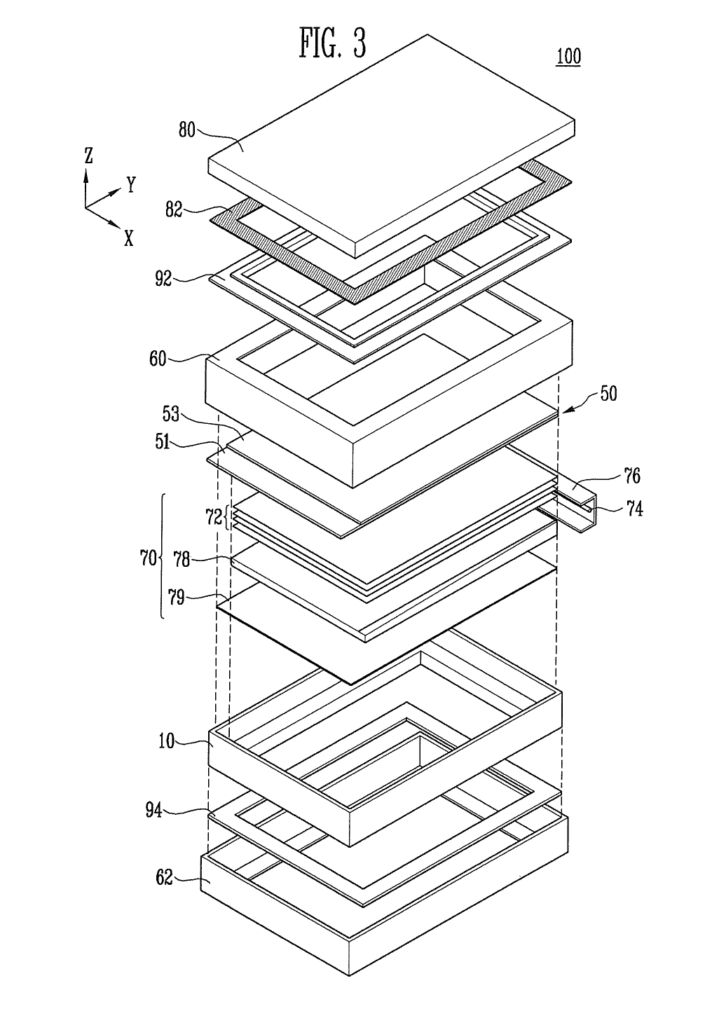

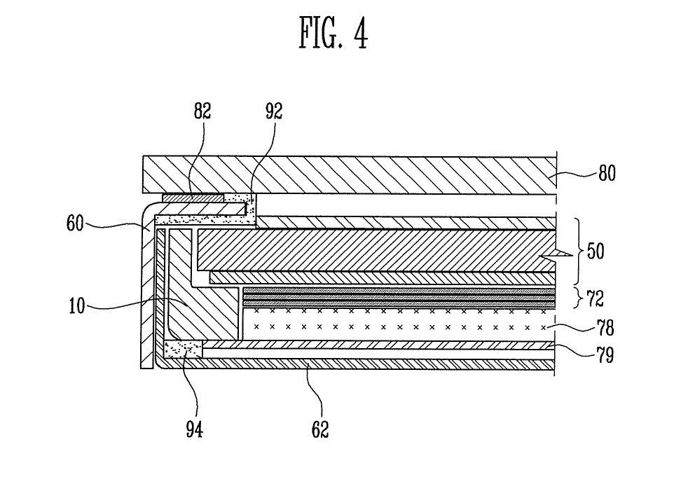

FIG. 3 is an exploded perspective view of an FPD integrated with a touch screen panel according to another embodiment of the present invention. FIG. 4 is a sectional view illustrating a part of FIG. 3.

Since the embodiment of FIG. 3 is substantially the same as the embodiment illustrated in FIGS. 1 and 2, and only the structure and position of the sealing material are different from the embodiments of FIGS. 1 and 2, like reference numerals refer to like elements and detailed description of the elements will be omitted.

Referring to FIGS. 3 and 4, the embodiment is different from the embodiment illustrated in FIGS. 1 and 2 in that a first sealing material 92 that contacts one surface of the double-sided tape 82 formed on the top chassis 60 and that wraps around the inside surface of the top chassis 60 and a second sealing material 94 positioned in a region between the bottom chassis 62 and the mold frame 10 are formed.

Here, as illustrated in FIG. 3, the first and second sealing materials 92 and 94 surround the four surfaces of the LCD and may have an elastic characteristic such as rubber.

That is, according to the embodiment illustrated in FIG. 3, the first and second sealing materials 92 and 94 are provided in the LCD to surround the four surfaces to prevent a foreign substance from penetrating the space created by the double-sided tape.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A display apparatus comprising:
a flat panel display (FPD);
a touch screen panel on a front surface of the FPD; and
a sealing material surrounding external surfaces of the FPD and the touch screen panel.

2. The display apparatus as claimed in claim 1, wherein the FPD comprises:
a backlight module for transmitting light generated by a light source;
a liquid crystal display (LCD) panel for displaying an image with the light;
a mold frame for fixing the backlight module and the LCD panel; and
a top chassis and a bottom chassis coupled to each other from top to bottom to fix the backlight module, the LCD panel, and the mold frame therebetween.

3. The display apparatus as claimed in claim 2, further comprising a double-sided tape for attaching the touch screen panel to a partial top surface of the top chassis.

4. The display apparatus as claimed in claim 1, wherein the sealing material comprises a synthetic resin material.

5. The display apparatus as claimed in claim 1, wherein the sealing material is formed by insert molding.

6. A display apparatus comprising:
a flat panel display (FPD) comprising a display panel, a mold frame for fixing the display panel, and a top chassis and a bottom chassis coupled to each other from top to bottom to fix the display panel and the mold frame therebetween;
a double-sided tape on a partial top surface of the top chassis;
a touch screen panel attached on a front surface of the FPD by the double-sided tape; and
a first sealing material being adapted to contact one surface of the double-sided tape formed on the top chassis and to wrap around an inside surface of the top chassis opposite to the partial top surface.

7. The display apparatus as claimed in claim 6, further comprising a second sealing material positioned at a region between the bottom chassis and the mold frame.

8. The display apparatus as claimed in claim 7, wherein the first sealing material or the second sealing material surrounds four surfaces of the FPD.

9. The display apparatus as claimed in claim 7, wherein the first sealing material or the second sealing material comprises an elastic material.

10. A display apparatus comprising:
a flat panel display (FPD) having a front side;
a touch screen panel on the front side of the FPD; and
a sealing material surrounding external surfaces of the FPD and the touch screen panel for sealing a space therebetween.

11. The display apparatus as claimed in claim 10, wherein the FPD comprises:
a display panel for displaying an image;
a top chassis and a bottom chassis coupled to each other with the display panel therebetween; and
a double-sided tape for attaching the touch screen panel to a partial top surface of the top chassis,
wherein the sealing material surrounds the double-sided tape.
